(19) United States
(12) Patent Application Publication
(10) Pub. No.: US 2009/0235872 A1
(43) Pub. Date: Sep. 24, 2009

(54) Increased occupancy time pet chews

(76) Inventors: Nevenka Filipi, St. Louis, MO (US); Nathan Everett Hill, St. Louis, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/317,184

(22) Filed: Dec. 19, 2008

Related U.S. Application Data
(60) Provisional application No. 61/069,988, filed on Mar. 19, 2008.
(60) Provisional application No. 61/130,290, filed on May 29, 2008.
(60) Provisional application No. 61/133,995, filed on Jul. 3, 2008.

(51) Int. Cl. A01K 29/00; A23G 4/20

(52) U.S. Cl. 119/710; 119/709; 426/5

(57) ABSTRACT

The invention provides increased occupancy time pet chews and methods of making and using the pet chews. The chews comprise a core comprising a comestible material, a shell surrounding the core, and an outer layer surrounding the shell. The outer layer comprises a comestible component such as grains, ground rawhide, or combination thereof and an optional basting material. The chews are used to occupy the attention of an animal and to promote the health and wellness of the animal.

### RELATED APPLICATIONS

This application claims priority to U.S. Provisional Application Ser. No. 61/069,988 filed Mar. 19, 2008, U.S. Provisional Application Ser. No. 61/130,290 filed May 29, 2008, and U.S. Provisional Application Ser. No. 61/133,995 filed Jul. 3, 2008, the disclosures of which are incorporated herein by this reference.

### BACKGROUND OF THE INVENTION

1. Field of the Invention

The invention relates generally to animal chews and treats and particularly to increased occupancy time pet chews and methods of making and using pet chews.

2. Description of the Related Art

Pet chews and treats are well known in the art. U.S. Pat. No. 6,840,196 discloses a rawhide pet chew made by folding a first sheet of rawhide around a second sheet of rawhide. The second sheet of rawhide is flavored to be appetizing to a pet, and the flavoring may impregnate the second sheet of rawhide. U.S. Pat. No. 7,194,981 discloses a rawhide pet chew made by folding a first sheet of rawhide around at least a second sheet of rawhide and a third sheet of rawhide. The second and third sheets of rawhide are flavored to be appetizing to a pet, and the flavoring may impregnate the second and third sheets of rawhide. U.S. Pat. No. 7,147,888 discloses emulsion impregnated rawhide chews containing substances for release into the oral cavity of pets during chewing, e.g., emulsions, surfactants, conditioners, flavorants and/or active ingredients. U.S. Pat. No. 7,288,275 discloses an animal chew formed by rolling a mixture of binder and base material into a sheet. Base material, such as an edible material, including but not limited to starch, protein matter, vegetable or plant matter, is mixed with a binder. The mixture is then supplied to a screw conveyor followed by introduction onto rollers to form a sheet. The sheet may then be cut into a desired shape. US2006081195A1 discloses a chew for domestic carnivorous animals comprising rawhide material and natural bone, characterized in that, said natural bone is wrapped up by said rawhide. US2007113796A1 discloses a pet chew comprising one or more nutraceutical agent(s) that includes fish oil. US2007289552A1 discloses an animal chew formed of rawhide and edible resin. The edible resin may be positioned on the outer surface of the rawhide and/or retained within the rawhide. The edible resin may include one or a mixture of starch, gluten, vegetable protein, carbohydrate or fat. WO07038655A2 discloses a pet chew impregnated with calcium, preferably precipitated calcium carbonate, as a whitening agent for rawhide chews.

Typically, an animal consumes chews over a relatively short period. For example, chews are usually consumed within several minutes by a typical animal such as a dog. As a result, keeping the animal occupied or entertained for a relatively long period using such chews requires feeding the animal several chews. This can lead to dietary issues for the animal such as a high caloric intake and nutrient imbalance caused by feeding numerous chews to the animal. There is, therefore, a need for new chews that are appealing to the animal and that provide increased occupancy times.

### SUMMARY OF THE INVENTION

In one aspect, the invention provides pet chews comprising a core comprising a comestible material, a shell surrounding the core, and an outer layer surrounding the shell. The outer layer comprises a comestible component such as grains, ground rawhide, or combination thereof and an optional basting material.

The comestible material can be any material suitable for consumption by an animal. In one embodiment, the comestible material comprises one or more ingredients such as carbohydrates, sugars, salts, proteins, fats, fibers, thickeners, emulsifiers, or combination thereof. In other embodiments, the comestible material comprises one or more ingredients such as flavors, aromas, palatability enhancers, vitamins, minerals, preservatives, or combination thereof. In further embodiments, the comestible material comprises one or more ingredients such as ground rawhide, flour, animal digest, peanut butter, or combination thereof.

The shell can be any material suitable for making a pet chew. In a preferred embodiment, the shell comprises one or more of rawhide, bio-plastics, or combinations thereof. In various embodiments, the bio-plastic is extruded rice, extruded corn, extruded millet, extruded wheat, or combination thereof.

The outer layer can be any suitable material that can be attached to the shell. In a preferred embodiment, the outer layer comprises a basting material such as maltodextrins, palatability enhancers, or combination thereof. In various embodiments, the palatability enhancers are colors, flavors, vitamins, minerals, preservatives, carbohydrates, sugars, salts, proteins, fats, fibers, thickeners, emulsifiers, or combination thereof.

The grain can be any grain suitable for consumption by an animal, e.g., buckwheat, barley, oats, wheat, rice, farro, flaxseed, rye, maize, spelt, teff, amaranth, millet, quinoa, sorghum, triticale, or combination thereof.

The outer layer can be attached to the shell using any suitable method known to skilled artisans. In a preferred embodiment, the outer layer is attached to the shell using a material such as melted gelatin, melted rawhide, melted collagen, or combination thereof.

In another aspect, the invention provides a method for entertaining or occupying the attention of an animal. The method comprises providing a chew comprising a core made of a comestible material, a shell surrounding the core, and an outer layer surrounding the shell to the animal. The shell can comprise a material such as rawhide, a bio-plastic, or combination thereof. The outer layer can comprise a comestible component such as grains, ground rawhide, or combination thereof. The outer layer may also comprise basting materials, palatability enhancers, or combination thereof as described herein. The chew occupies the attention of the animal for a longer period than a comparable chew that does not have the comestible component such as grains, ground rawhide, or combination thereof and the optional basting material.

In another aspect, the invention provides a method of making a chew. The method comprises providing a core made of a comestible material and surrounding the core with a shell. The shell can comprise a material such as rawhide, a bio-plastic, or combination thereof. The method further comprises surrounding the shell with an outer layer. The outer layer can comprise a comestible component such as grains, ground rawhide, or combination thereof. In an embodiment, the method comprises binding the outer layer to the shell using any suitable material such as melted gelatin, melted rawhide, melted collagen, or combination thereof. In another embodiment, the method comprises applying a basting material to the outer layer. The basting material can be maltodextrins, palatability enhancers, or combination thereof. In yet another embodiment, the invention provides a method of making a chew. The method comprises providing a shell made of a material such as rawhide, a bio-plastic, or combinations thereof and filling the shell with a core comprising a comestible material. The method further comprises surrounding the shell with an outer layer. The outer layer can comprise a comestible component such as grains, ground rawhide, or combination thereof.

An advantage of the invention is to provide an improved pet chew. Another advantage of the invention is to provide an improved method of making a pet chew. Still another advantage of the invention is to provide a way of entertaining an animal. Yet another advantage of the invention is to provide an improved long lasting chew.

Other and further objects, features, and advantages of the present invention will be readily apparent to those skilled in the art.

### BRIEF DESCRIPTION OF THE FIGURES

FIG. 1 illustrates an embodiment of the chew of the invention.

FIG. 2 illustrates the layers of the chew in an embodiment of the invention.

### DETAILED DESCRIPTION OF THE INVENTION

The invention is generally directed to pet chews and methods of making and using the pet chews. For example, in an embodiment, the pet chews have a unique combination of structure and ingredients that require more time to be chewed by an animal before the animal completely chews and consumes the product. The pet chew has an appealing flavor and visually pleasing appearance. Accordingly, the pet chew entertains or keeps the animal occupied for longer periods than the typical animal chew or treat, particularly a comparable chew that does not have the comestible component such as grains, ground rawhide, or combination thereof and the optional basting material. The chew is a long lasting pet chew that occupies the attention or entertains an animal for extended periods when provided to or fed to the animal. In addition, the pet chew comprises a nutritional combination of ingredients that benefit the health and wellness or well-being of the animal. The term “animal” means an animal that is capable of consuming a chew, including canine, equine, and feline animals. Preferably the chew is for dogs.

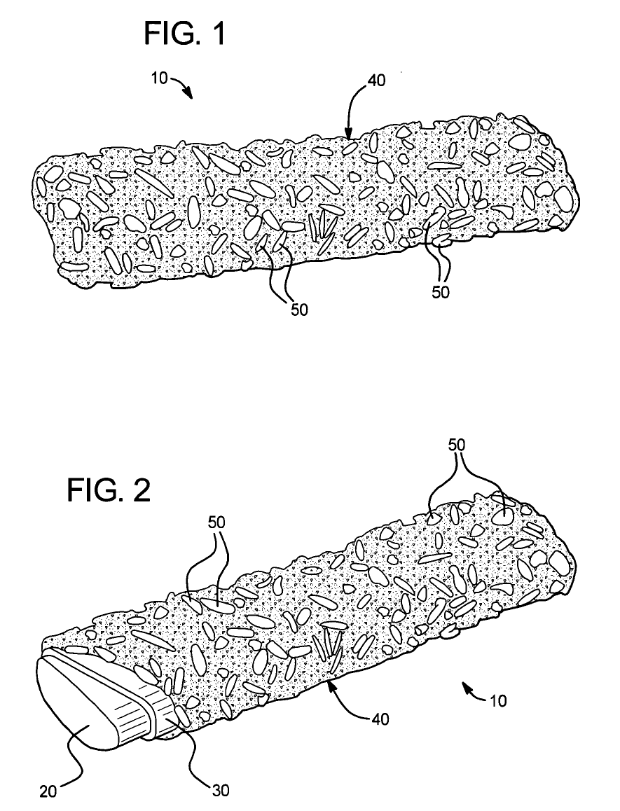

In an embodiment shown in FIGS. 1 and 2, the invention provides a chew 10 comprising a core 20 comprising a comestible material, an edible shell 30 surrounding the core 20, and an outer layer 40 surrounding the shell 30. The shell 30 can partially, substantially or completely surround the core 20. The outer layer 40 can comprise a comestible component 50 such as grains, ground rawhide, or combination thereof.

Although the chew 10 is shown in FIGS. 1 and 2 having an elongated rod shape, the chew 10 can comprise any suitable shape having a core, shell and outer layer in alternative embodiments. The chew 10 can have any desired dimensions. Generally, the product is in the shape of a rod, roll, or tube having a length of from about 1 to 24 inches and a diameter of from about 0.25 to 4 inches, preferably a length of from about 2 to 12 inches and a diameter of from about 0.5 to 2 inches, most preferably a length of from about 2 to 6 inches and a diameter of from about 0.5 to 1 inch.

The core 20 can contain any comestible material that is palatable to an animal. For example, the comestible material can comprise one or more ingredients such as carbohydrates, sugars, salts, proteins, fats, fibers (e.g. citrus fiber), thickeners (e.g. xanthan gum), emulsifiers (e.g. lecithin), or combination thereof. The comestible material can also comprise one or more ingredients such as flavors (e.g., chicken, beef, fish, etc.), aromas, palatability enhancers, vitamins, minerals, preservatives, or combination thereof. The comestible material can further comprise one or more specific food ingredients such as ground rawhide, vegetable flour, animal digest, peanut butter, or combination thereof.

In an embodiment, the shell 30 is made from rawhide (e.g. beef hide). As understood by the skilled artisan, rawhide is a byproduct of the slaughter of animals (e.g. hoofed animals such as cows, deer, etc.). Rawhide can be made from the hide and tendons of the animal. Typically, rawhide from the animal contains about 65-70% water and 30-35% dry material. The dry material can be made up of fibrous proteins, collagen, keratin, elastin and reticulin. The rawhide can be dried to form the shell. Although rawhide is tough and hard when dry, it is manageable and malleable when wet.

In another embodiment, the shell 30 is made from a bio-plastic. The bio-plastic can be made from expanded materials in feed constituents. For example, the bio-plastic can be in the form of extruded rice, extruded corn, extruded millet, extruded wheat, or combination thereof. The bio-plastic material can include additional constituents such as gelatin, dicalcium phosphate, a nutrient mixture, a reactive sugar, an amino acid, high-amylose or amylo-pectin component (such as starch) and/or inert (or non-digestible) fillers. The bio-plastic material may further include a preservative such as potassium sorbate, sorbic acid, methyl para-hydroxybenzoate, calcium propionate and/or propionic acid. Additional examples of the bio-plastics and methods of making the bio-plastics can be found in U.S. patent application Ser. No. 10/542,661, US20060292288A1, WO2004066748A1. In other embodiments, the “bio-plastic” comprises edible compositions having high structural integrity such as those disclosed in WO2007073903A1.

In an alternative embodiment, the shell 30 made by the rawhide and/or the bio-plastic can be further treated with one or more flavorings and preservatives before the outer layer 40 is applied. For example, the shell 30 can be soaked in a flavored/preservative solution. Alternatively, a flavored/preservative coating or gravy can be applied to the shell 30. The basting or steeping of the shell 30 in a flavored/preservative solution can cause the solution dry on the surface of the shell. The flavored/preservative solution can also be impregnated into the shell 30 rather than remaining at the surface of the shell 30.

The ground rawhide for the outer layer 40 can be in any suitable granular or powdered form. Non-limiting examples of the grains can include buckwheat, barley, oats, wheat, rice, farro, flaxseed, rye, maize, spelt, teff, amaranth, millet, quinoa, sorghum and/or triticale.

The outer layer 40 can be applied, attached to or provided on the shell 30 in any suitable manner, for example, using a suitable bonding material. The bonding material can be any edible bonding agent suitable for adhering the outer layer 40 to the shell 30. In an embodiment, the outer layer 40 is attached to the shell 30 using a material such as melted gelatin, melted rawhide, melted collagen, or combination thereof. For example, the ground rawhide and/or grains can be mixed with the melted materials and then applied to shell 30 in any suitable manner. The outer layer 40 can partially, substantially or completely surround the shell 30.

In another embodiment, the outer layer 40 comprises a basting material such as maltodextrins, palatability enhancers, or combination thereof. The palatability enhancers can be colors, flavors, vitamins, minerals, preservatives, carbohydrates, sugars, salts, proteins, fats, fibers, thickeners, emulsifiers, or combination thereof. The basting material can be in a solution form and be applied to the outer layer 40 in any suitable manner such as, for example, brushing, coating, spraying, etc.

In a preferred embodiment, the outer layer 40 comprises one or more grains, ground rawhide, or combination thereof and a basting material such as maltodextrins, palatability enhancers, or combination thereof. The outer layer is made by applying the grains and/or ground rawhide to the shell and then applying the basting material onto the grains and/or ground rawhide.

In one embodiment, the chew further comprises one or more health or wellness promoting agents incorporated into the chew. The term “health or wellness promoting agent” means any compound, composition, or drug useful for promoting health or wellness of an animal, including those for preventing or treating disease. The agent can be incorporated into any element of the chew including the core, shell, outer layer, or basting layer or material. The agent can be any agent compatible with the chew and that promotes the health or wellness of the animal, including drugs, vitamins, minerals, prebiotics, probiotics, peptidomimetics, electrolytes, antioxidants, peptides, medium chain triglycerides, herbal extracts, and the like. These chews are useful when it is difficult to get an animal to consume agents, particularly medications.

In another aspect, the invention provides a method for entertaining or occupying the attention of an animal. The method comprises providing a chew comprising a core comprising a comestible material, a shell surrounding the core, and an outer layer surrounding the shell to the animal. The shell can comprise a material such as rawhide, a bio-plastic, or combination thereof. The outer layer can comprise a comestible component such as grains, ground rawhide, or combination thereof. In preferred embodiments, the method comprises feeding the chew to the animal.

The chew in an embodiment of the invention has a longer chew time than comparable animal treats without the outer layer (e.g., grain coating or the basting layer). Apparently, although not bound by theory, the animal spends a significant amount of time consuming the outer layer/basting layer and then consumes the core and the shell. As a result, the animal can be occupied for a long time because it takes an extended period for the animal to completely consume the chew.

The chew can be made by any suitable process(es) for making multiple layer products. The chew can be made manually (e.g. by hand) or using automated processes. In an embodiment, the invention provides a method of making a chew. The method comprises providing a core comprising a comestible material and surrounding the core with a shell. For example, the core can be made and then the shell fitted around the core manually by a person or automatically using a machine. The shell can comprise a material such as rawhide, a bio-plastic, or combination thereof. The method further comprises surrounding the shell with an outer layer using any manual or automatic application process. The outer layer can comprise a comestible component such as grains, ground rawhide, or combination thereof.

In an embodiment, the method comprises binding the outer layer to the shell using a material such as melted gelatin, melted rawhide, melted collagen, or combination thereof. For example, the ingredients of the outer layer can be combined with the melted materials and then applied to the shell in any suitable manner. A basting material can also be applied to the outer layer. The basting material can be maltodextrins, palatability enhancers, or combination thereof.

In yet another embodiment, the method for making a pet chew comprises providing a shell made of a material such as rawhide, a bio-plastic, or combinations thereof and filling the shell with a core comprising a comestible material. For example, the shells can be pre-made and then filled manually by a person or automatically using a filling/depositing machine. The method further comprises surrounding the shell with an outer layer. The outer layer can comprise a comestible component such as grains, ground rawhide, or combination thereof. Alternatively, the shell can already have the outer layer before being filled with the core.

In one aspect, the invention provides methods for promoting health and/or wellness in an animal. The methods comprise feeding the animal one or more chews comprising a core comprising a comestible material, a shell surrounding the core, and an outer layer surrounding the shell. The outer layer comprises a comestible component such as grains, ground rawhide, or combination thereof. The chews occupy the animal and help satisfy the animal's need for food. As a result, the animal consumes less food and maintains a healthy weight. The satisfaction from consuming the chew, particularly over an extended period, contributes to the overall wellness of the animal. The methods are useful for promoting health or wellness of animals of any age or classification, including senior animals, geriatric animals, obese animals, and overweight animals. The term “health or wellness of an animal” means the complete physical, mental, and social well being of the animal, not merely the absence of disease or infirmity.

In a further aspect, the invention provides a means for communicating information about or instructions for one or more of (a) methods for feeding the chew of the invention to an animal, (b) methods for using the chew of the invention to promote the health or wellness of an animal, or (c) methods for using the chew of the invention to occupy or entertain an animal. The means comprises a document, digital storage media, optical storage media, audio presentation, or visual display containing the information or instructions. In certain embodiments, the communication means is a displayed web site, visual display kiosk, brochure, product label, package insert, advertisement, handout, public announcement, audiotape, videotape, DVD, CD-ROM, computer readable chip, computer readable card, computer readable disk, computer memory, or combination thereof containing such information or instructions. Useful information includes one or more of contact information for consumers to use if they have a question about the invention and its use.

In another aspect, the invention provides a package suitable of containing a chew of the invention comprising a label device indicating that the chew can be use to promote the health or wellness of an animal. The label can be any word or words, picture, design, acronym, slogan, phrase, or other device, or combination thereof that indicates that the invention promotes the health or wellness of an animal. Typically, such device comprises the words “promotes the health or wellness” or “enhances well-being” or “long lasting pet chew” or “occupies and entertains” or an equivalent expression printed on the package. Any package or packaging material suitable for containing melatonin is useful in the invention, e.g., a bag, box, bottle, can, pouch, and the like manufactured from paper, plastic, foil, metal, and the like.

In another aspect, the invention provides methods for improving oral health for an animal. The methods comprise feeding to the animal a chew comprising a core comprising a comestible material; a shell surrounding the core; and an outer layer surrounding the shell, the outer layer comprising a comestible component selected from the group consisting of grains, ground rawhide, and combinations thereof. The chew provides a mechanical action that cleans the teeth and interacts with the gums. The mechanical action improves oral health by preventing or limiting tooth decay and gun disease.

In another aspect, the invention provides methods for promoting healthy teeth and gums. The methods comprise feeding to the animal a chew comprising a core comprising a comestible material; a shell surrounding the core; and an outer layer surrounding the shell, the outer layer comprising a comestible component selected from the group consisting of grains, ground rawhide, and combinations thereof. The chew provides a mechanical action that cleans the teeth and interacts with the gums. The mechanical action promotes healthy teeth by preventing or limiting tooth decay and in healthy gums by preventing tooth decay and gun disease.

### EXAMPLES

The invention can be further illustrated by the following examples, although it will be understood that these examples are included merely for purposes of illustration and are not intended to limit the scope of the invention unless otherwise specifically indicated.

### Example 1

Chews containing no oats and no basting material were produced. Twenty (20) dogs were given a weighed chew and observed until the chew was consumed. The time lapsed from when the animal was given the chew until the chew was consumed was recorded. The results are shown in Table 1.

TABLE 1

| ANIMAL ID | OCCUPATION TIME (min) |
|---|---|
| D508 | 7.15 |
| D503 | 48.20 |
| V899 | 11.00 |
| D501 | 44.15 |
| V872 | 57.15 |
| V897 | 5.35 |
| F010 | 25.15 |
| F536 | 22.05 |
| V879 | 10.25 |
| F03 | 12.15 |
| D520 | 22.50 |
| V873 | 11.53 |
| D517 | 11.40 |
| F06 | 60.00 |
| F011 | 31.10 |
| U078 | 54.15 |
| V843 | 26.5 |
| V895 | 7.30 |
| AVERAGE | 25.95 |

### Example 2

Chews containing oats but no basting material were produced. Twenty (20) dogs were given a weighed chew and observed until the chew was consumed. The time lapsed from when the animal was given the chew until the chew was consumed was recorded. The results are shown in Table 2.

TABLE 2

| ANIMAL ID | OCCUPATION TIME (min) |
|---|---|
| D508 | 14.03 |
| D503 | 60.00 |
| V899 | 23.00 |
| D501 | 21.25 |
| V872 | 60.00 |
| V897 | 30.44 |
| F010 | 31.26 |
| F536 | 53.05 |
| V879 | 27.12 |
| F03 | 23.25 |
| D520 | 6.45 |
| V873 | 20.52 |
| D517 | 13.11 |
| F06 | 18.57 |
| U078 | 46.58 |
| U82 | 60.00 |
| V843 | 30.49 |
| V895 | 18.26 |
| AVERAGE | 30.97 |

### Example 3

Chews containing no oats but with basting material were produced. Twenty (20) dogs were given a weighed chew and observed until the chew was consumed. The time lapsed from when the animal was given the chew until the chew was consumed was recorded. The results are shown in Table 3.

TABLE 3

| ANIMAL ID | OCCUPATION TIME (min) |
|---|---|
| D508 | 21.45 |
| D503 | 28.35 |
| V899 | 25.45 |
| D501 | 34.55 |
| V872 | 44.10 |
| V897 | 26.00 |
| F010 | 39.35 |
| F536 | 37.20 |
| V879 | 38.30 |
| F03 | 18.35 |
| D520 | 17.56 |
| V873 | 20.05 |
| D517 | 13.04 |
| F06 | 14.37 |
| F011 | 23.42 |
| U078 | 40.30 |
| U82 | 40.25 |
| V843 | 11.59 |
| V895 | 9.53 |
| AVERAGE | 26.48 |

### Example 4

Chews containing oats and with basting material were produced. Twenty (20) dogs were given a weighed chew and observed until the chew was consumed. The time lapsed from when the animal was given the chew until the chew was consumed was recorded. The results are shown in Table 4.

TABLE 4

| ANIMAL ID | OCCUPATION TIME (min) |
|---|---|
| D508 | 5.32 |
| D503 | 9.20 |
| V899 | 25.22 |
| D501 | 22.30 |
| V872 | 60.00 |
| V897 | 36.05 |
| F010 | 26.05 |
| F536 | 15.00 |
| V879 | 37.35 |
| F03 | 60.00 |
| D520 | 19.14 |
| V873 | 13.58 |
| D517 | 28.28 |
| F06 | 46.47 |
| F011 | 18.55 |
| U078 | 33.30 |
| U82 | 60.00 |
| V895 | 13.06 |
| AVERAGE | 29.38 |

Referring to the Examples, the data show that the chews of the present invention have a longer chew time than the chews without the additional components of the present invention, i.e., the chews of the invention have increased occupancy time compared to chews that do not have an outer layer comprising a comestible component selected from the group consisting of grains, ground rawhide, and combinations thereof and/or a basting material.

All patents, patent applications, publications, technical and/or scholarly articles, and other references cited or referred to herein are in their entirety incorporated herein by reference to the extent allowed by applicable law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved. Full citations for publications not cited fully within the specification are set forth at the end of the specification.

In the specification, there have been disclosed typical preferred embodiments of the invention and, although specific terms are employed, they are used in a generic and descriptive sense only and not for purposes of limitation, the scope of the invention being set forth in the claims. Obviously many modifications and variations of the invention are possible in light of the above teachings. It is therefore to be understood that within the scope of the appended claims the invention may be practiced otherwise than as specifically described.

What is claimed is:

1. A chew comprising:
a core comprising a comestible material;
a shell surrounding the core; and
an outer layer surrounding the shell, the outer layer comprising a comestible component selected from the group consisting of grains, ground rawhide, and combinations thereof.

2. The chew of claim 1 wherein the comestible material comprises at least one ingredient selected from the group consisting of carbohydrates, sugars, salts, proteins, fats, fibers, thickeners, emulsifiers, and combinations thereof.

3. The chew of claim 1 wherein the comestible material comprises at least one ingredient selected from the group consisting of flavors, aromas, palatability enhancers, vitamins, minerals, preservatives, and combinations thereof.

4. The chew of claim 1 wherein the comestible material comprises at least one ingredient selected from the group consisting of ground rawhide, vegetable flour, animal digest, peanut butter, and combinations thereof.

5. The chew of claim 1 wherein the shell comprises rawhide.

6. The chew of claim 1 wherein the shell comprises a bio-plastic.

7. The chew of claim 6 wherein the bio-plastic is selected from the group consisting of extruded rice, extruded corn, extruded millet, extruded wheat, and combinations thereof.

8. The chew of claim 1 wherein the outer layer is attached to the shell using a material selected from the group consisting of melted gelatin, melted rawhide, melted collagen, and combinations thereof.

9. The chew of claim 1 wherein the outer layer comprises a basting material selected from the group consisting of maltodextrins, palatability enhancers, and combinations thereof.

10. The chew of claim 9 wherein the palatability enhancers are selected from the group consisting of colors, flavors, vitamins, mineral, preservatives, carbohydrates, sugars, salts, proteins, fats, fibers, thickeners, emulsifiers, and combinations thereof.

11. The chew of claim 1 wherein the grain is selected from the group consisting of buckwheat, barley, oats, wheat, rice, farro, flaxseed, rye, maize, spelt, teff, amaranth, millet, quinoa, sorghum, triticale, and combinations thereof.

12. A method for occupying the attention of an animal comprising:
providing a chew comprising a core comprising a comestible material, a shell surrounding the core, the shell comprising a material selected from the group consisting of rawhide, a bio-plastic, and combinations thereof, and an outer layer surrounding the shell, the outer layer comprising a comestible component selected from the group consisting of grains, ground rawhide, and combinations thereof; and
feeding the chew to the animal.

13. The method of claim 12 wherein the outer layer comprises a basting material selected from the group consisting of maltodextrins, palatability enhancers, and combinations thereof.

14. A method of making a chew comprising:
providing a core comprising a comestible material;
surrounding the core with a shell, the shell comprising a material selected from the group consisting of rawhide, a bio-plastic, and combinations thereof; and
surrounding the shell with an outer layer, the outer layer comprising a comestible component selected from the group consisting of grains, ground rawhide, and combinations thereof.

15. The method of claim 14 wherein the comestible material comprises at least one ingredient selected from the group consisting of carbohydrates, sugars, salts, proteins, fats, fibers, thickeners, emulsifiers, and combinations thereof.

16. The method of claim 14 wherein the comestible material comprises at least one ingredient selected from the group consisting of flavors, aromas, palatability enhancers, vitamins, minerals, preservatives, and combinations thereof.

17. The method of claim 14 comprising binding the outer layer to the shell using a material selected from the group consisting of melted gelatin, melted rawhide, melted collagen, and combinations thereof.

18. The method of claim 14 comprising applying a basting material to the outer layer, the basting material being selected from the group consisting of maltodextrins, palatability enhancers, and combinations thereof.

19. The method of claim 18 wherein the palatability enhancers are selected from the group consisting of colors, flavors, vitamins, minerals, preservatives carbohydrates, sugars, salts, proteins, fats, fibers, thickeners, emulsifiers, and combinations thereof.

20. The method of claim 14 wherein the grain is selected from the group consisting of buckwheat, barley, oats, wheat, rice, farro, flaxseed, rye, maize, spelt, teff, amaranth, millet, quinoa, sorghum, triticale, and combinations thereof.
